(19) United States
(12) Patent Application Publication
(10) Pub. No.: US 2025/0222871 A1
(43) Pub. Date: Jul. 10, 2025

(54) VEHICLE LADDER

(71) Applicant: Jiangsu Off-Road Gonghe Culture Co., Ltd., Zhenjiang (CN)

(72) Inventor: Qi Gu, Zhenjiang (CN)

(21) Appl. No.: 19/089,101

(22) Filed: Mar. 25, 2025

(30) Foreign Application Priority Data
Mar. 25, 2024 (CN) 202420577565.5

(51) Int. Cl. B60R 3/02

(52) U.S. Cl. CPC B60R 3/02

(57) ABSTRACT

A new-type vehicle ladder is provided, belonging to the field of car ladders. The new-type vehicle ladder includes a main body and a ladder assembly. The main body is a long-bar shaped accommodation frame for accommodating and fixing the ladder assembly. The ladder assembly includes a telescopic mechanism, a turning mechanism, support rods and a plurality of step plates. The telescopic mechanism is located at one end of the main body. The turning mechanism is connected to the telescopic mechanism. The turning mechanism is capable of rotating on the connecting rod. The support rod includes a first support rod and a second support rod. The new-type vehicle ladder will not cause damage to a vehicle sheet metal, nor block the view of a rearview mirror.

### TECHNICAL FIELD

The present disclosure belongs to the field of car ladders, more particularly to a new-type vehicle ladder.

### BACKGROUND

At present, commonly known vehicle ladders are installed near the rear window glass on two sides of vehicles. A bracket at an upper end of the ladder is fixed to a roof luggage rack, and a lower end thereof is attached to a vehicle sheet metal. However, the common vehicle sheet metal does not have enough strength to support the weights of the ladder and the user. Therefore, this type of vehicle ladders might cause certain damage to the vehicle sheet metal. Furthermore, they might also block the view of a rearview mirror, which can easily result in danger during driving.

### SUMMARY

In order to solve the above problems in the existing technologies, the present disclosure provides a new-type vehicle ladder, which will not cause damage to a vehicle sheet metal, nor block the view of a rearview mirror.

In order to achieve the above object, the present disclosure provides the following technical solution. A new-type vehicle ladder includes a main body and a ladder assembly. The main body is a long-bar shaped accommodation frame for accommodating and fixing the ladder assembly. The ladder assembly includes a telescopic mechanism, a turning mechanism, support rods and a plurality of step plates. The telescopic mechanism is located at one end of the main body. The turning mechanism is connected to the telescopic mechanism. One end of the support rod is connected to the turning mechanism. The step plates are arranged on the support rod evenly. The support rod is turned outward by means of the turning mechanism during downward rotation thereof.

Further, the telescopic mechanism includes a telescopic member and a connecting rod. The telescopic member drives the connecting rod to telescope.

Further, the turning mechanism is connected onto the connecting rod. The connecting rod is provided with a turning block.

Further, one end of the support rod is pressed against the turning block after being connected to the turning mechanism.

Further, one end of the support rod is moveably connected to the turning mechanism and is capable of rotating on the turning mechanism. The turning mechanism is capable of rotating on the connecting rod.

Further, when the support rod is received into the main body, the step plates are folded into the support rod.

Further, the support rod includes a first support rod and a second support rod. The second support rod is connected onto the first support rod and is capable of sliding on the first support rod. One end of the first support rod is connected to the turning mechanism.

Compared to the existing technologies, the present disclosure has the following beneficial effects. The present disclosure has an ingenious design. Through the cooperation between the telescopic mechanism, the turning mechanism and the support rods, no damage will be caused to a vehicle sheet metal. By adoption of multiple sections of support rods, the ladder can directly extend to the ground, which is convenient for people to climb. The present disclosure can be installed on two sides of a luggage rack on a vehicle roof or on a vehicle roof platform by means of a connecting bracket, which will not block the view of a rearview mirror and will improve the safety of driving.

### BRIEF DESCRIPTION OF THE DRAWINGS

FIG. 1 is a structure diagram of the present disclosure in a storage state.

FIG. 2 is a structure diagram of the present disclosure in a fully unfolded state.

FIG. 3 is an exploded view of the present disclosure.

FIG. 4 is a structure diagram of the present disclosure during an unfolding process.

### DETAILED DESCRIPTION OF THE EMBODIMENTS

The technical solutions of the embodiments of the present disclosure will be clearly and completely described below with reference to the drawings of the embodiments of the present disclosure. Apparently, the described embodiments are merely part embodiments of the present disclosure, rather than all of the embodiments. All of the other embodiments that a person skilled in the art obtains on the basis of the embodiments of the present disclosure without paying creative work are intended to fall within the protection scope of the present disclosure.

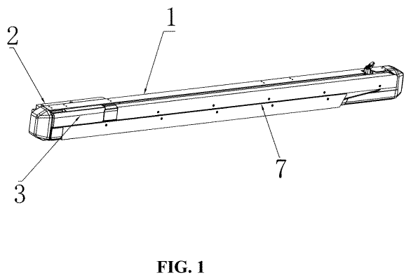

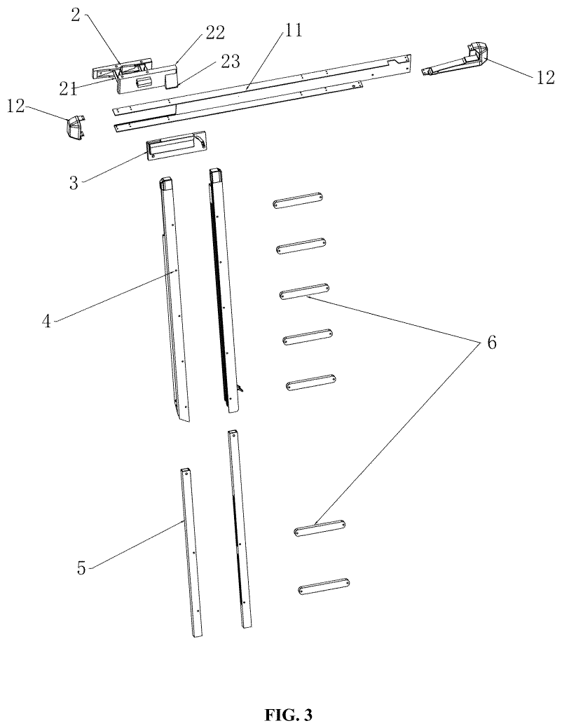

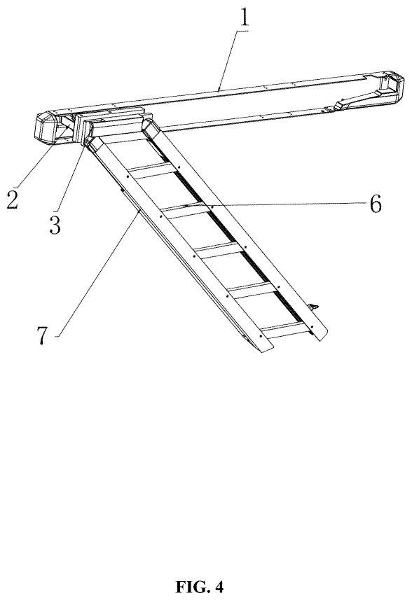

Referring to FIG. 1 to FIG. 4, the present disclosure provides the following technical solution. A new-type vehicle ladder includes a main body 1 and a ladder assembly. The main body 1 is a long-bar shaped accommodation frame for accommodating and fixing the ladder assembly. The main body 1 includes a ladder housing 11 and decorative covers 12. The decorative covers 12 are fixed on two ends of the ladder housing 11. The ladder housing 11 is provided with a fixing portion. The ladder assembly can be folded into a long bar shape and fixed into the main body 1 when not used. The ladder assembly includes a telescopic mechanism 2, a turning mechanism 3, support rods 7 and a plurality of step plates 6. The telescopic mechanism 2 is located at one end of the main body 1. The turning mechanism 3 is connected to the telescopic mechanism 2. One end of the support rod 7 is connected to the turning mechanism 3. The step plates 6 are arranged on the support rod 7 evenly. The vehicle ladder is fixed on two sides of a luggage rack on a vehicle roof or on a vehicle roof platform by means of a connecting bracket, whereby not blocking the view of a rearview mirror. By means of the telescopic mechanism 2, the telescopic mechanism 2 itself, the turning mechanism 3, the support rod 7 and the plurality of step plates 6 are pulled out from the main body 1 together. Then, during the downward rotation of the support rod 7, the support rod 7 is turned outward by means of the turning mechanism 3. And finally, the support rod 7 is supported on the ground and does not attach to a vehicle sheet metal, whereby causing no damage to the vehicle sheet metal.

Specifically, the telescopic mechanism 2 includes a telescopic member 21 and a connecting rod 22. The telescopic member 21 drives the connecting rod 22 to telescope. The turning mechanism 3 is connected onto the connecting rod 22. In this manner, by pulling the telescopic mechanism 2, the telescopic member 21 is pulled out, and the connecting rod 22, the turning mechanism 3, the support rod 7 and the step plates 6 are pulled out too.

Specifically, the connecting rod 22 is provided with a turning block 23. One end of the support rod 7 is pressed against the turning block 23 after being connected to the turning mechanism 3. One end of the support rod 7 is moveably connected to the turning mechanism 3 and is capable of rotating on the turning mechanism 3, and the turning mechanism 3 is capable of rotating on the connecting rod 22. When rotating the support rod 7, one end of the support rod 7 is pushed outward by the turning block 23, and at this time the support rod 7 causes the turning mechanism 3 to turn outward.

Specifically, when the support rods 7 are received into the main body 1, the step plates 6 are folded into the support rods 7. The support rods 7 are folded in a staggered manner and contract to become a long bar shape, and the step plates 6 fit with the support rods 7, for convenience of storage.

Specifically, the support rod 7 includes a first support rod 4 and a second support rod 5. The second support rod 5 is connected onto the first support rod 4 and is capable of sliding on the first support rod 4. When the support rod 7 is rotated into place, in order to increase the length, it is just needed to slide down the second support rod 5 from the first support rod 4.

Specifically, one end of the first support rod 4 is connected to the turning mechanism 3. Both the first support rod 4 and the second support rod 5 are provided with step plates 6 evenly.

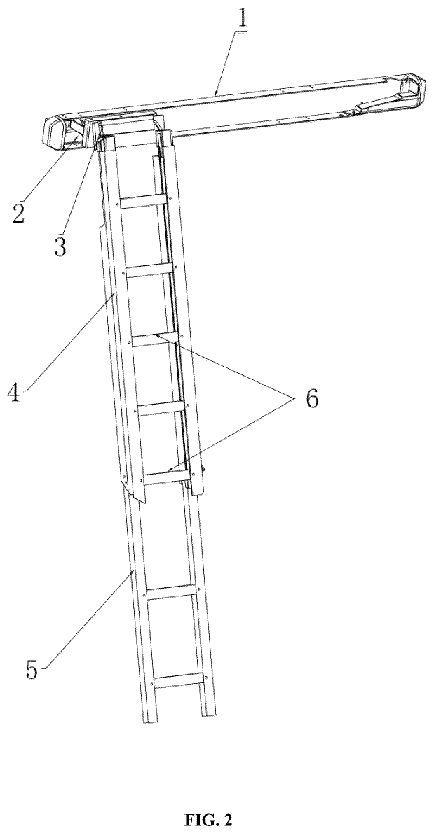

The operation process of the present disclosure is as follows. When in use, the fixing portion is unlocked first, and then the ladder assembly is pulled outward. As a consequence, the telescopic mechanism 2, the turning mechanism 3, the support rods 7 and the step plates 6 are pulled out from the main body 1 together. Next, the support rods 7 are rotated downward. During the rotation of the support rods 7, the support rods 7 are pushed outward by the turning block 23 on the connecting rod 22, and meanwhile the support rods 7 cause the turning mechanism 3 to rotate outward. When the support rods 7 are rotated to the vertical direction, the support rods 7 are unfolded in parallel autonomously, where the step plates 6 are connected cross-wise between the support rods. Finally, the second support rod 5 is slid out of the first support rod 4, and then the vehicle ladder is fully unfolded, as shown in FIG. 2. When not in use, first, the second support rod 5 is slid into the first support rod 4, and then the support rods 7 are rotated to the horizontal direction, whereby the support rods 7 are folded and contract into a long bar shape. Finally, the telescopic mechanism 2, the turning mechanism 3, the support rods 7 and the step plates 6 are pushed into the main body 1 together, and then the vehicle ladder is fully stowed, as shown in FIG. 1.

Finally, it should be noted that the above are preferred embodiments of the present disclosure merely and are not intended to limit the present disclosure. Although the present disclosure has been described in detail by reference to the above mentioned embodiments, for those skilled in the art, modifications also can be made to the technical scheme recorded in each embodiment mentioned above, or partial technical features can be substituted equivalently. Any modifications, equivalent substitutes and improvements, etc., made within the spirit and principle of the present disclosure all are included in the protection scope of the present disclosure.

What is claimed is:

1. A new-type vehicle ladder, comprising a main body (1) and a ladder assembly, the main body (1) being a long-bar shaped accommodation frame for accommodating and fixing the ladder assembly, and the ladder assembly comprising a telescopic mechanism (2), a turning mechanism (3), support rods (7) and a plurality of step plates (6); the telescopic mechanism (2) being located at one end of the main body (1), the turning mechanism (3) being connected to the telescopic mechanism (2), one end of the support rod (7) being connected to the turning mechanism (3), the step plates (6) being arranged on the support rod (7) evenly, and the support rod (7) being turned outward by means of the turning mechanism (3) during downward rotation thereof.

2. The new-type vehicle ladder according to claim 1, wherein the telescopic mechanism (2) comprises a telescopic member (21) and a connecting rod (22), and wherein the telescopic member (21) drives the connecting rod (22) to telescope.

3. The new-type vehicle ladder according to claim 2, wherein the turning mechanism (3) is connected onto the connecting rod (22), and wherein the connecting rod (22) is provided with a turning block (23).

4. The new-type vehicle ladder according to claim 3, wherein one end of the support rod (7) is pressed against the turning block (23) after being connected to the turning mechanism (3).

5. The new-type vehicle ladder according to claim 4, wherein one end of the support rod (7) is moveably connected to the turning mechanism (3) and is capable of rotating on the turning mechanism (3), and wherein the turning mechanism (3) is capable of rotating on the connecting rod (22).

6. The new-type vehicle ladder according to claim 5, wherein when the support rod (7) is received into the main body (1), the step plates (6) are folded into the support rod (7).

7. The new-type vehicle ladder according to claim 6, wherein the support rod (7) comprises a first support rod (4) and a second support rod (5), wherein the second support rod (5) is connected onto the first support rod (4) and is capable of sliding on the first support rod (4), and wherein one end of the first support rod (4) is connected to the turning mechanism (3).
